(19) United States
(12) Patent Application Publication
(10) Pub. No.: US 2004/0174421 A1
(43) Pub. Date: Sep. 9, 2004

(54) Ink-jet printer

(76) Inventor: Masaaki Tsuji, Wakayama-shi (JP)

Correspondence Address: SMITH PATENT OFFICE, 1901 PENNSYLVANIA AVENUE N W, SUITE 200, WASHINGTON, DC, 20006

(21) Appl. No.: 10/752,091

(22) Filed: Jan. 7, 2004

(30) Foreign Application Priority Data
Jan. 10, 2003 (JP) 2003-5132

(51) Int. Cl. B41J 2/01

(52) U.S. Cl. 347/104

(57) ABSTRACT

Under a platen having many holes formed therein, disposed are plural suction fans corresponding to respective papers conveyed in parallel. A partitioning member is arranged between the suction fans and the platen to form air passages each corresponding to each of the papers. When printing is performed on only a part of the plural papers that may be conveyed in parallel, the plural suction fans are controlled such that only the suction fan corresponding to the paper to be printed, among the plural suction fans, may suck air, and the other suction fans not corresponding to the paper may not suck air.

### BACKGROUND OF THE INVENTION

1. Field of the Invention

The present invention relates to an ink-jet printer that ejects ink onto a printing medium to perform printing.

2. Description of Related Art

Some ink-jet printers perform printing by ejecting ink onto a paper as a printing medium from a printing head that reciprocates perpendicularly to a paper conveyance direction. It is important, from the viewpoint of printing quality, to ensure flatness of the paper in a region confronting the printing head. Thus, particularly when a long paper is used as the printing medium, there may be adopted an approach in which many holes are formed in a platen that supports the paper in the region confronting the printing head and a suction fan disposed under the platen generates suction force through the holes to thereby bring the paper into close contact with a surface of the platen. In general, the holes are formed on the entire surface of the platen in a substantially uniform pattern, and a single suction fan is disposed. The suction force of the single suction fan generates airflow through all the holes formed in the platen.

In this type of printer, sometimes, two relatively narrow papers may be conveyed in parallel and subjected to printing simultaneously so as to improve processing performance of the printer. In this case, each of the two papers conveyed in parallel receives the suction force substantially over its entire surface, and is thereby brought into close contact with the surface of the platen.

When printing is to be performed on only one of the two papers that may be conveyed in parallel, the one paper is solely conveyed onto the platen and the other paper is not conveyed onto the platen. At this time, the paper closes, among all the many holes formed in the platen, the holes formed within an area where the one paper passes during its conveyance, i.e., within a paper passing area, from the ones located upstream in the paper conveyance direction. However, the holes other than those formed within the one paper passing area, including the holes formed within the other paper passing area, are not closed with the other paper and therefore remain opened. When the suction fan drives in this condition, a large amount of air flows into the holes that remain opened. Therefore, there arises a problem that airflow generated by the suction force of the suction fan leads away ink that is ejected by the printing head toward the one paper, to result in decreased ink-landing accuracy and thus deterioration in printing quality. This problem becomes more significant particularly when a paper to be printed has printing performed on a vicinity of its edge nearer a passing area of another paper that undergoes no printing.

### SUMMARY OF THE INVENTION

An object of the present invention is to provide an ink-jet printer capable of ensuring flatness of a printing medium and at the same time restraining a decrease in ink-landing accuracy, even when printing is performed on only a part of plural printing media that may be arranged in parallel.

According to an aspect of the present invention, there is provided an ink-jet printer comprising: a supporting member that supports a printing medium and has plural holes formed therein; an ink ejecting member capable of ejecting ink toward a printing medium supporting side of the supporting member; plural suction members capable of sucking air through the holes from a printing medium supporting side of the supporting member to an opposite side thereof; a partitioning member that partitions a space between the plural suction members and the supporting member to thereby form plural air passages; and a suction controller that controls the suction members such that, when the printing medium supporting side of the supporting member has a printing medium arranged thereon in only a part of plural regions each corresponding to each of the plural air passages and the ink ejecting member ejects ink toward the printing medium, only the suction member corresponding to the region where the printing medium is arranged, among the plural suction members, may suck air.

According to the aforementioned aspect, the plural suction members are provided and, further, the partitioning member partitions a space between the plural suction members and the supporting member to thereby form the plural air passages. Then, when the printing medium is arranged in only a part of the regions each corresponding to each of the air passages and printing is performed on the printing medium, only the suction member corresponding to the region where the printing medium is arranged, among the plural suction members, may suck air. In other words, among the plural suction members, the suction member corresponding to the region where the printing medium is not arranged cannot suck air. As a result, since no air flows into the holes formed in the region where no printing medium is arranged, it can be prevented that airflow leads away ink that is ejected by the ink ejecting member toward the printing medium. That is, according to the aforementioned aspect, even when printing is performed on only a part of plural printing media that may be arranged in parallel, flatness of the printing medium can be ensured and, at the same time, a decrease in ink-landing accuracy can be restrained.

### BRIEF DESCRIPTION OF THE DRAWINGS

Other and further objects, features and advantages of the invention will appear more fully from the following description taken in connection with the accompanying drawings in which:

FIG. 1 schematically illustrates a construction of an ink-jet printer according to an embodiment of the present invention;

FIG. 2 is a partial top view around a platen in the ink-jet printer of FIG. 1;

FIG. 3 is a partial side view around the platen in the ink-jet printer of FIG. 1;

FIG. 4 is a partial top view illustrating that the ink-jet printer of FIG. 1 performs printing on only one of two papers arranged in parallel; and

FIG. 5 is a partial top view illustrating that the ink-jet printer of FIG. 1 performs printing on both of two papers arranged in parallel.

### DESCRIPTION OF THE PREFERRED EMBODIMENTS

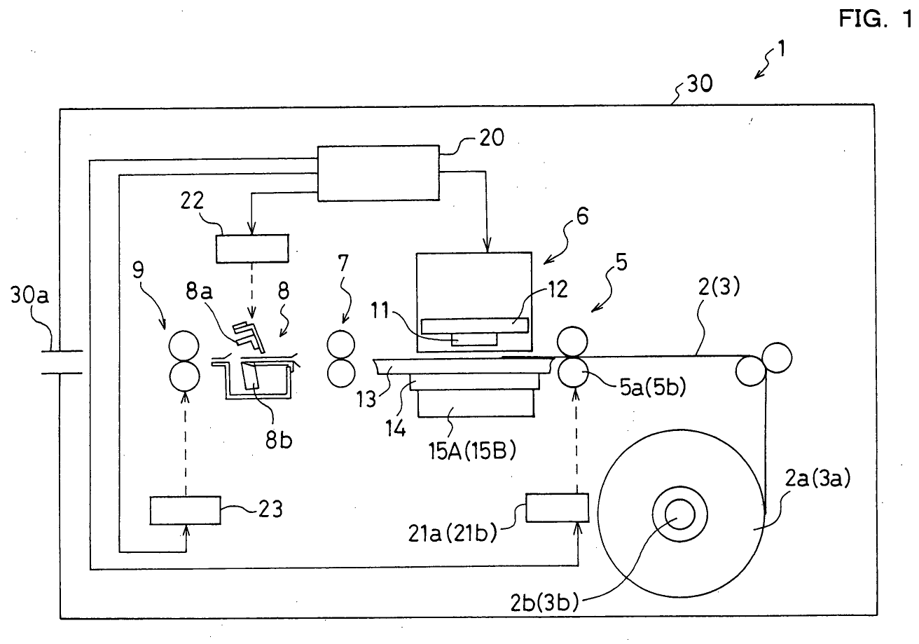

An ink-jet printer 1 illustrated in FIG. 1 has a substantially rectangular parallelepiped casing 30. The casing 30 includes therein a conveyance roller unit 5, an ink-jet printing unit 6, a press roller unit 7, a cutting unit 8, and a discharge roller unit 9 in this order from upstream in a paper conveyance direction. In the casing 30, additionally, arranged are two roll portions 2a and 3a formed by rolling respective long papers 2 and 3 as printing media. The roll portions 2a and 3a are supported on drums 2b and 3b so as to rotate around their axes, and arranged adjacently to each other in a horizontal direction, i.e., a direction perpendicular to the drawing sheet of FIG. 1, with a predetermined distance therebetween. The conveyance roller unit 5, the press roller unit 7, and the discharge roller unit 9 constitute a conveyance mechanism that conveys the papers 2 and 3. A controller 20 arranged within the casing 30 controls an operation of each part of the ink-jet printer 1.

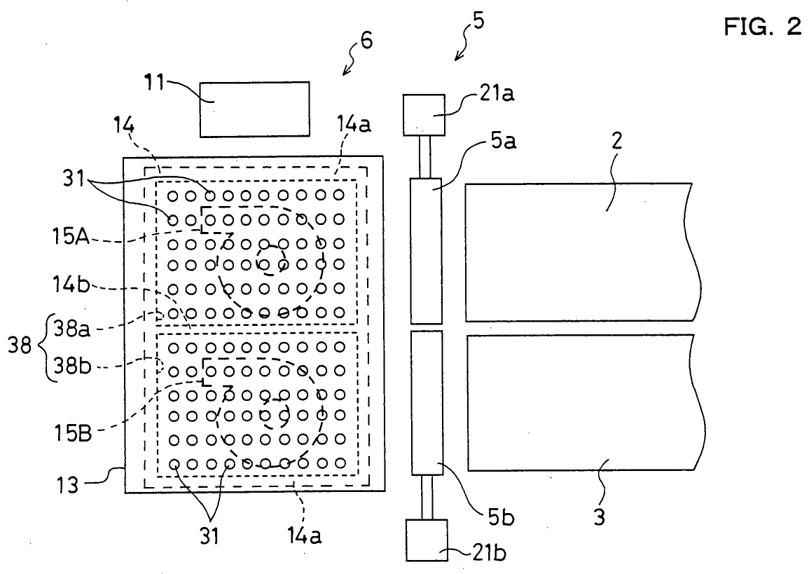

The conveyance roller unit 5 unwinds the papers 2 and 3 from the roll portions 2a and 3a to convey them downstream in the conveyance direction, then passes the papers 2 and 3 through the ink-jet printing unit 6, and then supplies the papers 2 and 3 to the press roller unit 7. As illustrated in FIG. 2, the conveyance roller unit 5 has two pairs of conveyance rollers 5a and 5b that are arranged coaxially and adjacently to each other so as to correspond to the two papers 2 and 3, respectively. As illustrated in FIG. 1, each of the pairs of conveyance rollers 5a and 5b includes a drive roller disposed under a paper conveyance path and a press roller disposed over the paper conveyance path to press against the drive roller. The rollers are all disposed with their axes being perpendicular to the paper conveyance direction. The respective drive rollers are rotated by driving of respective motors 21a and 21b controlled by the controller 20. Each of the two papers 2 and 3 is pinched with the drive roller and the press roller of each pair of conveyance rollers 5a or 5b, and, in this condition, conveyed in accordance with rotations of the drive roller.

As illustrated in FIG. 1, the ink-jet printing unit 6 has a printing head 11 as an ink ejecting member, a carriage 12, a platen 13 as a supporting member, an air passage member 14, and two suction fans 15A and 15B as suction members.

The printing head 11 has, on its lower face or on its face confronting the papers 2 and 3, a large number of ejection nozzles (not illustrated) for ejecting color inks such as yellow, magenta (purplish red), cyan (bluish green), and black. The printing head 11 can, based on a signal from the controller 20, eject the color inks through the large number of ejection nozzles onto surfaces or upper faces in FIG. 1 of the papers 2 and 3 being conveyed, to thereby print desired color images on the papers.

The printing head 11 may have ejection nozzles that eject plural color inks, color combination of which is other than the aforementioned, or may have a large number of ejection nozzles for only black ink to print monochrome images. The ink-jet printing unit 6 may be a piezo-jet type, a thermal-jet type, or any other types, as long as ejecting liquid ink through nozzles dot by dot to perform printing on the papers 2 and 3.

The carriage 12 holds the printing head 11 on its lower face such that the printing head 11 may confront the papers 2 and 3. The carriage 12 is, together with the printing head 11, reciprocatable perpendicularly to the paper conveyance direction, i.e., perpendicularly to the drawing sheet of FIG. 1. The printing head 11 held by the carriage 12 ejects ink onto the surfaces of the papers 2 and 3 while reciprocating with the carriage 12 perpendicularly to the paper conveyance direction.

The platen 13 supports the papers 2 and 3 in a region confronting the printing head 11. A surface, upper face in FIG. 1, of the platen 13 serves as a paper supporting side as a printing medium supporting side that is substantially on the same plane as a conveyance surface for the papers 2 and 3. Thus, the printing head 11 performs printing on the papers 2 and 3 arranged on the platen 13 while reciprocating along a widthwise direction of the platen 13 in a state of confronting the surface of the platen 13.

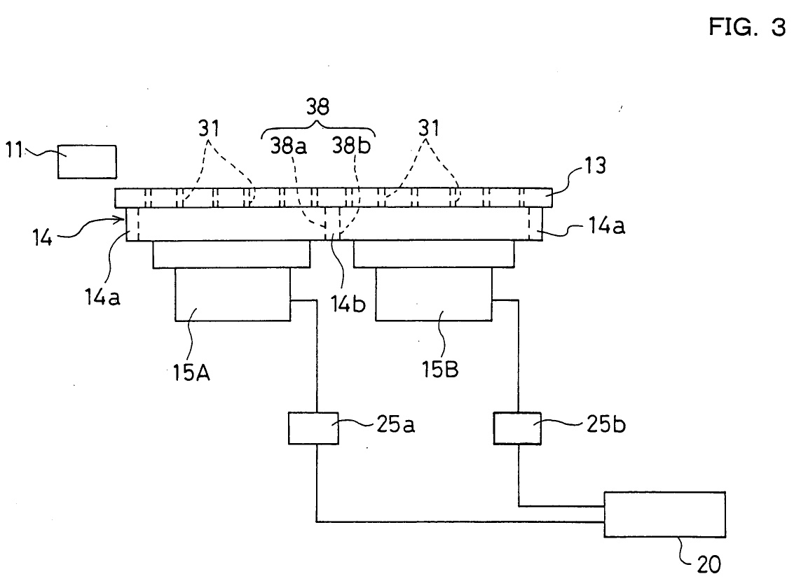

As illustrated in FIGS. 2 and 3, the platen 13 has many substantially circular holes 31 uniformly formed almost over the entire surface thereof. FIGS. 2 to 5 show just an example of holes formed in the platen 13, and the holes may be variously changed in number, shape, and arrangement.

As illustrated in FIGS. 1 to 3, the air passage member 14 is a rectangular-cylindrical member having, in a plan view, a rectangular shape slightly smaller than the platen 13. The air passage member 14 is disposed between the platen 13 and the suction fans 15A and 15B. The air passage member 14 has a side wall 14a and a partition wall 14b as a partitioning member. Both of the side wall 14a and the partition wall 14b extend in a vertical direction or in the same direction as a thickness direction of the platen 13. As illustrated in FIG. 2, the side wall 14a is arranged around a circumference of the air passage member 14, and defines a cavity 38 formed inside the air passage member 14. The partition wall 14b is arranged along the paper conveyance direction at a center of the air passage member 14, and divides the cavity 38 into two air passages 38a and 38b. The air passages 38a and 38b, each having a rectangular shape in a plan view, are so arranged as to correspond to the papers 2 and 3, respectively.

The suction fans 15A and 15B are so disposed under the air passage member 14 as to correspond to the air passages 38a and 38b, i.e., the papers 2 and 3, respectively. The suction fans 15A and 15B can suck air from a top face side to a back face side of the platen 13 through the holes 31 and the air passages 38a and 38b, respectively. The papers 2 and 3 having reached the ink-jet printing unit 6 are brought into close contact with the surface of the platen 13 by means of suction force of the suction fans 15A and 15B, and is conveyed at a fixed distance from the printing head 11. This can prevent deterioration in printing quality resulting from a change in distance between the papers 2, 3 and the printing head 11 caused when the papers 2 and 3 are curled to partially get away from the platen 13 to a larger extent.

Each of the suction fans 15A and 15B is connected to each of two motors 25a and 25b driven under the control of the controller 20, and thus can be individually controlled by the controller 20. That is, the controller 20 constitutes a suction controller of the present invention.

The press roller unit 7 pinches and conveys the papers 2 and 3 that are conveyed from the ink-jet printing unit 6 to the cutting unit 8. The press roller unit 7 is disposed between the ink-jet printing unit 6 and the cutting unit 8, so that printing on the papers 2 and 3 by the ink-jet printing unit 6 and cutting of the papers 2 and 3 by the cutting unit 8 can properly be performed.

The cutting unit 8 has a movable cutting blade 8a disposed on the same side of the papers 2 and 3 as the printing head 11, and a fixed cutting blade 8b disposed on the opposite side to the movable cutting blade 8a across the papers 2 and 3. Each of the movable cutting blade 8a and the fixed cutting blade 8b is a rectangular-shaped blade having a width extending over the two papers 2 and 3 in order to cut, at one time, the two papers 2 and 3 arranged in parallel. The movable cutting blade 8a is movable to get closer to or apart from the fixed cutting blade 8b by driving of a motor 22 that is under the control of the controller 20. Accordingly, the movable cutting blade 8a cooperates with the fixed cutting blade 8b to cut the printed papers 2 and 3, which have been conveyed to the cutting unit 8, along a widthwise direction of the papers 2 and 3. The printed papers 2 and 3 are thus cut into predetermined lengths.

The discharge roller unit 9 includes a pair of drive rollers rotated by driving of a motor 23, and conveys the papers 2 and 3 having cut by the cutting unit 8 to discharge them through a discharge port 30a. The motor 23 is controlled by the controller 20.

The controller 20 subjects an image signal supplied from a non-illustrated input interface to a predetermined process, and then supplies, to the ink-jet printing unit 6, a print signal including image data corresponding to an image to be printed. The controller 20 also controls timings for conveying the papers 2 and 3 at the conveyance roller unit 5 and at the discharge roller unit 9, a timing for moving the carriage 12, a timing for ejecting ink from the printing head 11, a timing for sucking air with the suction fans 15A and 15B, a timing for cutting the papers 2 and 3 at the cutting unit 8, and the like.

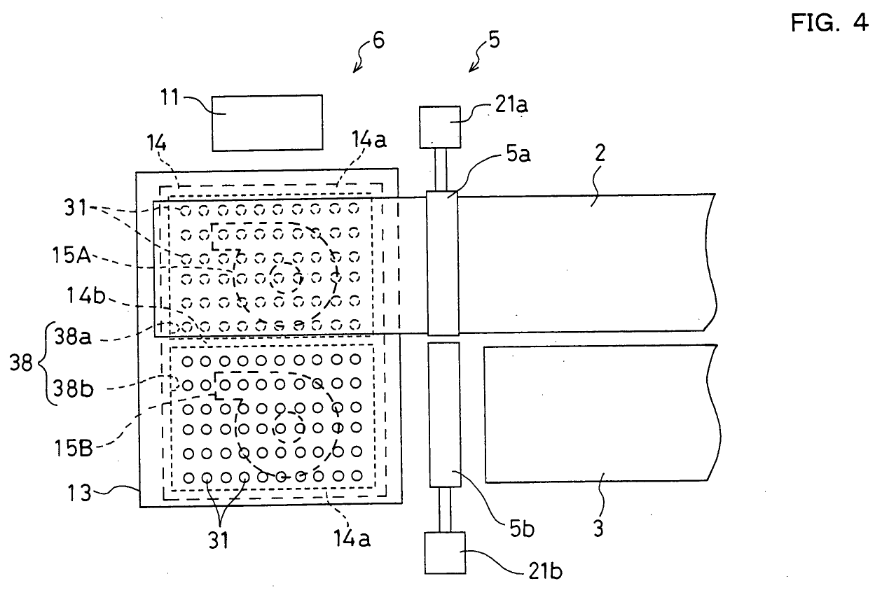

Next, with reference to FIG. 4, a description will be given to how each part of the ink-jet printer 1 operates when printing is performed on only one paper 2 out of the two papers 2 and 3 arranged in parallel.

First, the motor 21a drives to rotate one pair of conveyance rollers 5a of the conveyance roller unit 5, so that the paper 2 is unwound from the roll portion 2a (see FIG. 1) and conveyed onto the platen 13. At this time, the motor 21b does not drive, and accordingly the other pair of conveyance rollers 5b of the conveyance roller unit 5 stays stopping without a rotation.

In association with a conveyance of the paper 2 on the platen 13, the paper 2 gradually closes the holes 31 formed within a passing area thereof, sequentially from the ones located upstream in the paper conveyance direction. FIG. 4 illustrates a state where a leading edge of the paper 2 has almost reached an end of the platen 13 on a downstream side in the paper conveyance direction. The paper 2 arranged on the platen 13 is brought into close contact with the surface of the platen 13 by means of the suction force generated by the suction fan 15A through the holes 31 formed within the passing area of the paper 2 and through the air passage 38a.

At this time, the controller 20 so controls the suction fans 15A and 15B as to drive only the suction fan 15A corresponding to the paper 2 and not to drive the suction fan 15B corresponding to the other paper 3. Therefore, when printing is performed on only one paper 2 out of the two papers 2 and 3 arranged in parallel, the holes 31 formed within a passing area of the other paper 3, i.e., the holes 31 communicating with the air passage 38b corresponding to the suction fan 15B, remain opened. However, there is generated little suction force through those holes 31 and the air passage 38b.

When the paper 2 arrives at a region, in the surface of the platen 13, over which the printing head 11 passes, i.e., at an ink ejection region, the printing head 11 starts reciprocating perpendicularly to the paper conveyance direction. The paper 2 is kept stopping during a reciprocation of the printing head 11, and conveyed in the paper conveyance direction by a predetermined feeding amount when the printing head 11 is temporarily stopping before every forward or backward movement thereof. That is, a forward or backward movement of the printing head 11 and a conveyance of the paper 2 by the predetermined feeding amount are alternately repeated. The printing head 11 ejects ink onto the paper 2 during their reciprocations to thereby perform printing. The printing head 11 may perform printing during any one of forward and backward movements.

Although a case of printing on the paper 2 has been described above, printing on the other paper 3 is performed likewise.

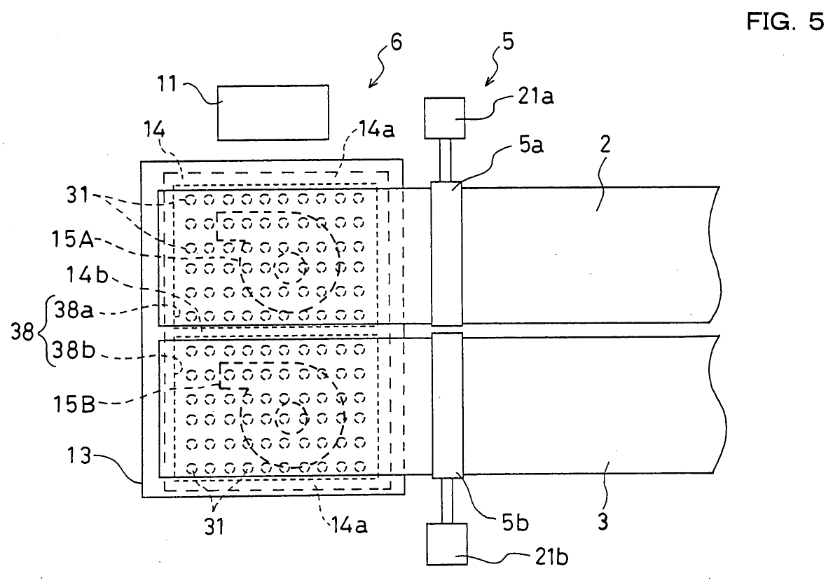

Then, with reference to FIG. 5, a description will be given to how each part of the ink-jet printer 1 operates when printing is performed on both papers 2 and 3 arranged in parallel.

First, the motors 21a and 21b drive to rotate the respective pairs of conveyance rollers 5a and 5b of the conveyance roller unit 5, so that the papers 2 and 3 are unwound from the roll portions 2a and 3a (see FIG. 1), respectively, and conveyed onto the platen 13. In association with a conveyance of the papers 2 and 3 on the platen 13, the papers 2 and 3 gradually close the holes 31 formed in the platen 13, sequentially from the ones located upstream in the paper conveyance direction. FIG. 5 illustrates a state where leading edges of the papers 2 and 3 have almost reached an end of the platen 13 on a downstream side in the paper conveyance direction.

At this time, the controller 20 drives both the suction fans 15A and 15B that are so disposed as to correspond to the papers 2 and 3, respectively. Therefore, the papers 2 and 3 arranged on the platen 13 are brought into close contact with the surface of the platen 13 by means of the suction force generated by the respective suction fans 15A and 15B through the holes 31 formed in the passing areas of the papers 2 and 3 and through the air passages 38a and 38b.

A forward or backward movement of the printing head 11 and a conveyance of the papers 2 and 3 by a predetermined feeding amount are alternately repeated in the same manner as described above, so that printing is performed on the papers 2 and 3.

As described above, according to the ink-jet printer 1, the two suction fans are provided, and the partition wall 14b of the air passage member 14 partitions a space between the two suction fans 15A, 15B and the platen 13 to thereby form the two air passages 38a and 38b. When printing is performed on a single paper arranged on any one of two regions corresponding to the respective air passages 38a and 38b, only one suction fan, out of the two suction fans 15A and 15B, corresponding to the region where the paper is arranged is capable of sucking air. In other words, the other suction fan corresponding to the region where no paper is arranged cannot suck air. As a result, since no air flows into the holes 31 formed in the region where no paper is arranged, it can be prevented that airflow leads away ink that is ejected by the printing head 11 toward the paper. That is, according to this embodiment, even when printing is performed on only a part of plural papers that may be conveyed in parallel, flatness of the paper can be ensured and, at the same time, a decrease in ink-landing accuracy can be restrained.

The foregoing problem of decreased ink-landing accuracy due to airflow becomes more significant particularly when a paper to be printed has printing performed on a vicinity of its edge nearer a passing area of another paper that undergoes no printing. In this embodiment, however, this problem is relieved and thus the vicinity of the above-mentioned edge experiences printing with considerably improved printing quality.

Moreover, since the two suction fans 15A and 15B are provided for the single platen 13, a small-sized suction fan may be adopted. This can provide an increased variety of arrangement of the suction fans 15A and 15B. Thus, a space for arranging the suction fans 15A and 15B can be reduced.

Further, according to the printer 1 of this embodiment, even when printing is performed on both of the two papers 2 and 3 arranged in parallel as described above, flatness of the papers 2 and 3 can be ensured by driving both of the suction fans 15A and 15B that correspond to the respective papers 2 and 3. The printer 1 of this embodiment may be used not only when papers are conveyed in parallel, but also, for example, when a single paper having a width extending over the passing areas of the papers 2 and 3 is conveyed. In this case as well, flatness of the paper can be ensured by driving both of the two suction fans 15A and 15B.

Although the air passage member 14 of the aforementioned embodiment has the side wall 14a, the side wall 14a may be omitted and the air passage member 14 may have only the partition wall 14b that partitions the space between the two suction fans 15A, 15B and the platen 13.

In addition, although the aforementioned embodiment illustrates that the papers 2 and 3 are conveyed onto the platen 13 to be printed thereon, this is not limitative. This invention may also be applied when the papers 2 and 3 are put on the platen 13 by hand to be printed thereon.

Further, although the aforementioned embodiment illustrates that the two papers 2 and 3 are conveyed in parallel, this is not limitative. This invention may also be applied when three or more papers are conveyed in parallel. In such a case, it is preferable to form air passages corresponding to the respective papers by using partitioning members such as the partition wall 14b.

Still further, although the aforementioned embodiment illustrates that printing is performed on the long papers 2 and 3 that have been unwound from the roll portions 2a and 3a and then conveyed, cut papers with a predetermined length may be conveyed to be printed thereon.

Various media such as thin plastics, instead of papers, may be adopted as a printing medium for the ink-jet printer of the present invention.

An application of the present invention is not limited to a so-called serial-type printer in which, as in the aforementioned embodiment, printing is performed with the printing head 11 that reciprocates perpendicularly to the paper conveyance direction. The present invention is applicable also to a line-type printer that performs printing with a fixed printing head.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. An ink-jet printer comprising:
a supporting member that supports a printing medium and has plural holes formed therein;
an ink ejecting member capable of ejecting ink toward a printing medium supporting side of the supporting member;
plural suction members capable of sucking air through the holes from a printing medium supporting side of the supporting member to an opposite side thereof;
a partitioning member that partitions a space between the plural suction members and the supporting member to thereby form plural air passages; and
a suction controller that controls the suction members such that, when the printing medium supporting side of the supporting member has a printing medium arranged thereon in only a part of plural regions each corresponding to each of the plural air passages and the ink ejecting member ejects ink toward the printing medium, only the suction member corresponding to the region where the printing medium is arranged, among the plural suction members, may suck air.

2. The ink-jet printer according to claim 1, further comprising a conveyance mechanism capable of conveying plural printing media in parallel,
wherein the plural air passages are so formed as to correspond to the respective plural printing media conveyed by the conveyance mechanism.
